(19) United States
(12) Patent Application Publication
(10) Pub. No.: US 2007/0214313 A1
(43) Pub. Date: Sep. 13, 2007

(54) Apparatus, system, and method for concurrent RAID array relocation

(76) Inventors: Matthew Joseph Kalos, Tucson, AZ (US); Robert Akira Kubo, Tucson, AZ (US); Richard Anthony Ripberger, Tucson, AZ (US); Cheng-Chung Song, Tucson, AZ (US)

Correspondence Address: Kunzler & McKenzie, 8 EAST BROADWAY, SUITE 600, SALT LAKE CITY, UT, 84111, US

(21) Appl. No.: 11/358,486

(22) Filed: Feb. 21, 2006

(51) Int. Cl. G06F 12/16; G06F 13/00

(52) U.S. Cl. 711/114; 711/165

(57) ABSTRACT

An apparatus, system, and method are disclosed for concurrently relocating a RAID array. The apparatus includes an identification module, a designation module, and an implementation module. The identification module identifies an availability of a physical device within a donor arrayed storage device to offload a source drive of a relocation enclosure. The designation module designates an available physical device as a target drive and thereby designate the target drive and the source drive as a linked pair;. The implementation module implements a mirroring relationship between the target drive and the source drive. The apparatus, system, and method provide a dynamic relocation of the raid array, minimizing system downtime and maximizing efficient utilization of system resources.

### BACKGROUND

1. Field of Art

This invention relates to arrayed storage devices and more particularly relates to dynamically relocating a RAID array from one physical location and/or system to another physical location and/or system while maintaining concurrent I/O access to the entire data set of the systems.

2. Background Technology

Today, more than ever, computer systems continue to experience major improvements in processing power and overall system performance. However, as computing power has increased by several orders of magnitude over time, I/O throughput has generally failed to keep up. A technology invented by IBM® that has helped to narrow this gap between system performance and I/O latency is Redundant Array of Independent Disks (RAID) technology, also referred to as Redundant Array of Inexpensive Disks.

An array is an arrangement of related hard-disk-drive modules assigned to a group. There are varied versions of RAID, but generally, RAID is a redundant array of hard-disk drive modules. A typical RAID system comprises a plurality of hard disk drives configured to share and/or replicate data among the multiple drives. A plurality of physical device enclosures may be installed, where each physical device enclosure encloses a plurality of attached physical devices, such as hard disk drives.

At the original introduction of the hard disk drive, storage devices were thought of in terms of physical devices. A small system may comprise a single drive, possibly with multiple platters. A large system may comprise multiple drives attached through one or more controllers, such as a DASD (direct access storage device) chain. A DASD is a form of magnetic disk storage, historically used in the mainframe and minicomputer (mid-range) environments. A RAID is a form of DASD. Direct access means that all data can be accessed directly, in a form of indexing also known as random access, as opposed to storage systems based on seeking sequentially through the data (e.g., tape drives).

As the need for storage space outpaced storage cost, the concept of a logical device on a RAID storage system was devised. A logical device, or logical drive, is an array of independent physical devices mapped to appear as a single logical device. Thus, the logical device appears to a host computer as a single local hard disk drive.

Originally, the key advantage of a RAID system was the ability to combine multiple low-cost hard drives using older technology that offered increased speed, capacity, and/or reliability when compared to a single device using the latest technology. For that reason, the “I” in RAID was originally understood to mean inexpensive, and this still holds true in many situations, such as in cases where IDE/ATA (integrated drive electronics/advanced technology attachment) disks are used.

However, the inexpensive IDE/ATA RAID systems generally use a single RAID controller, introducing a single point of failure for the RAID system. More commonly, SCSI (small computer system interface) hard disks are used for mission-critical RAID computing, using a plurality of multi-channel SCSI or Fiber Channel RAID controllers, where the emphasis is placed on the independence and fault-tolerance of each independent RAID controller. This way, each physical device within the array may be accessed independently of the other physical devices. A SCSI RAID system has the added benefit of a dedicated processor on each RAID controller to handle data access, relieving the host computer processor to perform other tasks as required.

Depending on the version of RAID used, the benefit of RAID may be I/O throughput, storage capacity, fault-tolerance, data integrity or any combination thereof. As today's business success relies more and more on the rapid transfer and processing of data, RAID provides an industry-standard platform to meet the needs of today's business-critical computing, a technology that is extremely effective in implementing demanding, transaction-oriented applications.

The original RAID specification suggested a number of prototype RAID levels, or varying combinations and configurations of storage devices. Each level had theoretical advantages and disadvantages. Over the years, different implementations of the RAID concept have appeared. Most differ substantially from the original conceived RAID levels, but the numbered names have remained.

A RAID level 0, or RAID 0 (also known as a striped set) is the simplest form of RAID. RAID 0 splits data evenly across two or more disks with no parity information for redundancy to create a single, larger device. RAID 0 does not provide redundancy. RAID 0 only offers increased capacity, but can be configured to also provide increased performance and throughput. RAID 0 is the most cost-efficient form of RAID storage, however, the reliability of a given RAID 0 set is equal to (1−Pf)ⁿ where Pf is the failure rate of one disk and n is the number of disks in the array. That is, reliability decreases exponentially as the number of disks increases.

In a RAID 1 configuration, also known as mirroring, every device is mirrored onto a second device. The focus of a RAID 1 system is on reliability and recovery without sacrificing performance. Every write to one device is replicated on the other. RAID 1 is the most expensive RAID level, since the amount of physical devices installed must be double the amount of usable space in a RAID 0 configuration. RAID 1 systems provide full redundancy when independent RAID controllers are implemented.

A RAID 2 stripes data at the bit-level, and uses a Hamming code for error correction. The disks are synchronized by the RAID controller to run in tandem. A RAID 3 uses byte-level striping with a dedicated parity disk. One of the side effects of RAID 3 is that multiple requests cannot generally be serviced simultaneously.

A RAID 4 uses block-level striping with a dedicated parity disk. RAID 4 looks similar to RAID 3 except that stripes are at the block, rather than the byte level. A RAID 5 uses block-level striping with parity data distributed across all member disks. RAID 5 is one of the most popular RAID levels, and is frequently used in both hardware and software implementations.

A RAID 6 extends RAID 5 by adding an additional parity block, thus RAID 6 uses block-level striping with two parity blocks distributed across all member disks. RAID 6 was not one of the original RAID levels. RAID 6 provides protection against double disk failures and failures while a single disk is rebuilding.

A RAID controller may allow RAID levels to be nested. Instead of an array of physical devices, a nested RAID system may use an array of RAID devices. In other words, a nested RAID array is a logically linked array of physical devices which are in turn logically linked into a single logical device. A nested RAID is usually signified by joining the numbers indicating the RAID levels into a single number, sometimes with a plus sign in between.

A RAID 0+1 is a mirror of stripes used for both replicating and sharing data among disks. A RAID 1+0, or RAID 10, is similar to a RAID 0+1 with exception that the order of nested RAID levels is reversed: RAID 10 is a stripe of mirrors. A RAID 50 combines the block-level striping with distributed parity of RAID 5, with the straight block-level striping of RAID 0. This is a RAID 0 array striped across RAID 5 elements.

An enterprise RAID system may comprise a host adapter, a plurality of multi-channel RAID controllers, a plurality of storage device enclosures comprising multiple storage devices each, and a system enclosure, which may include fans, power supplies and other fault-tolerant features. RAID can be implemented either in dedicated hardware or custom software running on standard hardware. Additionally, there are hybrid RAID systems that are partly software-based and partly hardware-based solutions.

A RAID system may offer hot-swappable drives and some level of drive management tools. Hot-swap allows a system user to remove and replace a failed drive without shutting down the bus, or worse, the system to which the drive is attached. With a hot-swap enabled system, drives can be removed with the flip of a switch or a twist of a handle, safely detaching the drive from the bus without interrupting the RAID system.

The manner in which RAID arrays and logical configurations are created within a system and the impacts of device failures and maintenance activities can cause, over time, the physical location of logical devices to migrate to different physical device enclosures. Because of such behaviors it is not only possible but somewhat likely that over time the physical location of storage devices that comprise logical devices of RAID arrays may move from their original location.

In RAID storage systems, the RAID controller controls the logical relationship between the logically linked physical devices. The physical location of a logical device is relatively independent of the RAID controller's location, as long as the RAID controller maintains access to the logically linked physical devices.

In a DASD system, the physical devices may be interconnected by a communications protocol designed to allow a distributed configuration of the physical devices. Thus, the physical devices may be attached in a uniform modular grouping of physical devices such that the configuration can grow incrementally by adding additional physical device enclosures and DASD.

In addition to providing a system user a straightforward method for adding additional physical device enclosures and DASD to the system, additional benefit would come from the added ability to remove and relocate attached physical device enclosures and DASD currently attached to the system.

A system user may wish to add storage capacity to a new system where an existing system comprises unused/available storage that is compatible with the new system. Rather than purchase additional incremental infrastructure of physical device enclosures and DASD, it would be beneficial to develop and provide a method to remove existing infrastructure of physical device enclosures and DASD from an existing system and relocate the physical device enclosures and DASD to the new system.

Continuous availability is currently the expectation that many users have of their DASD storage systems. Considering the continuous availability expectation, it is apparent that a concurrent method of organizing RAID array devices and their physical location is needed to provide a capability to remove a discrete enclosure entity and any associated DASD for relocation to another system.

Currently, when a device is removed from a RAID system, the system is instantly placed in degraded mode. When a RAID system is running with one or more failed or missing drives, the RAID system is said to be running in degraded mode. Data availability is not interrupted, but the RAID system would be open to failure if one of the remaining partner drives should fail. Thus, a method to relocate existing infrastructure of physical device enclosures and DASD would avoid operating the RAID system in degraded mode, maintain concurrent I/O access to the entire data set, and provide uninterrupted availability to mission-critical system applications.

### SUMMARY

The several embodiments of the present invention have been developed in response to the present state of the art, and in particular, in response to the problems and needs in the art that have not yet been fully solved by currently available RAID array relocation methods. Accordingly, the present invention has been developed to provide an apparatus, system, and method for concurrent RAID array relocation that overcome many or all of the above-discussed shortcomings in the art.

The apparatus to relocate a RAID array is provided with a logic unit containing a plurality of modules configured to functionally execute the necessary operations for non-interruptive relocation of a RAID array concurrent with other tasks and operations. These modules in the described embodiments include an identification module, a designation module, and an implementation module. Further embodiments include a search module, a selection module, a copy module, an update module, a integration module, a transition module and a notification module.

The identification module identifies a physical device attached to an arrayed storage device as available to offload the data contents of a source drive attached to a donor arrayed storage device. The identification module includes a search module and a selection module.

In one embodiment, the identification module may identify an arrayed storage device connected to a storage system supports removal of an enclosure. The identification module may then identify an arrayed storage device as a candidate for the donor arrayed storage device. Additionally, the identification module may identify an enclosure attached to the donor arrayed storage device as a candidate for the relocation enclosure.

The search module searches for a best match to a physical device attached to the relocation enclosure in order to offload a mirror copy of all stored data from the physical device attached to the relocation enclosure to a physical device attached to another enclosure. In one embodiment, the search module may search an arrayed storage device for a specified size and type of enclosure according to characteristics of a preferred relocation enclosure.

The selection module selects a best match to offload the mirror copy of all stored data from the physical device attached to the relocation enclosure to a physical device attached to another enclosure. In one embodiment, the selection module may select an arrayed storage device in order to search for an arrayed storage device that supports removal of an attached enclosure.

The designation module designates a best match to a physical device attached to a relocation enclosure as a target drive. The designation module may also designate the physical device attached to the relocation enclosure as a source drive. Thus, the designation module designates a pairing of a source drive linked to a target drive.

The implementation module implements a mirroring relationship between a source drive and a target drive. The implementation module includes a copy module that copies the data from the source drive to the target drive, and an update module that synchronizes updates between the source drive and the target drive concurrent to the copy process.

The copy module copies the mirror image of all stored data from a source drive to a target drive. In one embodiment, the copy module copies the data from the source drive to the target drive concurrent to other tasks running on the donor arrayed storage device, thus maintaining access to all stored data and availability to mission-critical applications.

Throughout the copy process, the update module synchronizes any update issued to the source drive with the target drive. Thus, updates to the source drive are synchronized concurrently to the target drive throughout the copy process. In one embodiment, the update module passes updates to the source drive and the target drive at the same time.

The integration module integrates a target drive as full RAID array member. The target drive is thus integrated when the new data from the source drive is copied and stored. The integration module may receive a signal from the copy module indicating the copy process is completed. The copy module may signal the completion of the copy process to the transition module additionally. Accordingly, the implementation module may then remove the mirroring relationship between the source drive and the target drive.

The transition module transitions the source drive to a free-state. Once the transition module transitions every source drive attached to the relocation enclosure, the transition module may then signal the notification module that all source drives are released into a free-state, and that all target drives are transitioned to full RAID array members.

The notification module notifies the system user of the free-state status of the relocation enclosure. In certain embodiments, the notification module notifies the system user that the copy process has finished successfully and that the relocation enclosure is currently safe to remove from the donor arrayed storage device. The system user is then free to remove and relocate the relocation enclosure from the donor arrayed storage device and install the relocation enclosure in the recipient arrayed storage device.

The determination module determines whether an arrayed storage device contains a specified size and type of enclosure. In one embodiment, the determination module determines the characteristics of the specified enclosure for relocation as specified by a system user. In other embodiments, the determination module determines the characteristics of the specified enclosure for relocation as specified by a host computer or some other autonomous process.

A system of the present invention is also presented for non-interruptively relocating a RAID array concurrent with other tasks and operations. The system may be embodied in an array storage controller, the array storage controller configured to execute a RAID array relocation process.

In particular, the system, in one embodiment, may include a host computer configured to interface a plurality of arrayed storage devices, a donor arrayed storage device selected from the plurality of arrayed storage devices coupled to the host computer, the donor arrayed storage device configured to donate a relocation enclosure, and a recipient arrayed storage device selected from the plurality of arrayed storage devices coupled to the host computer, the recipient arrayed storage device configured to receive a relocation enclosure.

The system also includes a relocation apparatus coupled to the donor arrayed storage device, the relocation apparatus configured to process operations associated with a relocation procedure to relocate a RAID array concurrent with other tasks and operations. The system may also include an arrayed storage controller, the arrayed storage controller configured to control operations of an arrayed storage device.

In a further embodiment, the system may include a relocation enclosure, the relocation enclosure configured for removal from the donor arrayed storage device and relocation to the recipient arrayed storage device.

A signal bearing medium is also presented to store a program that, when executed, performs operations for concurrently relocating a RAID array. In one embodiment, the operations include identifying an availability of a physical device within a donor arrayed storage device to offload a source drive of a relocation enclosure, designating an available physical device as a target drive and thereby designating the target drive and the source drive as a linked pair, and implementing a mirroring relationship between the target drive and the source drive.

In another embodiment, the operations may include searching among a plurality of physical devices within the donor arrayed storage device for the availability to offload a source drive of a relocation enclosure and searching among a plurality of available physical devices for a best match to the source drive, selecting among a plurality of physical devices within the donor arrayed storage device one or more available physical devices and selecting among the available physical devices a best match to the source drive, copying the entire data content of the source drive to the target drive, and synchronizing an update to the source drive with the target drive concurrent with a copy process of the copy module.

In a further embodiment, the operations may include integrating the target drive as a full array member of the donor arrayed storage device in response to the copy module signaling the entire data content of the source drive is mirrored on the target drive, transitioning the source drive to a free state in response to the copy module signaling the entire data content of the source drive is mirrored on the target drive, and notifying a system user the relocation enclosure is available for removal.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a storage system;

FIG. 2 is a schematic block diagram illustrating one embodiment of an arrayed storage device;

FIG. 3 is a schematic block diagram illustrating one embodiment of a relocation apparatus;

FIG. 4 is a schematic block diagram illustrating one embodiment of a donor arrayed storage device; and

FIGS. 5A, 5B and 5C are a schematic flow chart diagram illustrating one embodiment of a relocation method.

### DETAILED DESCRIPTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

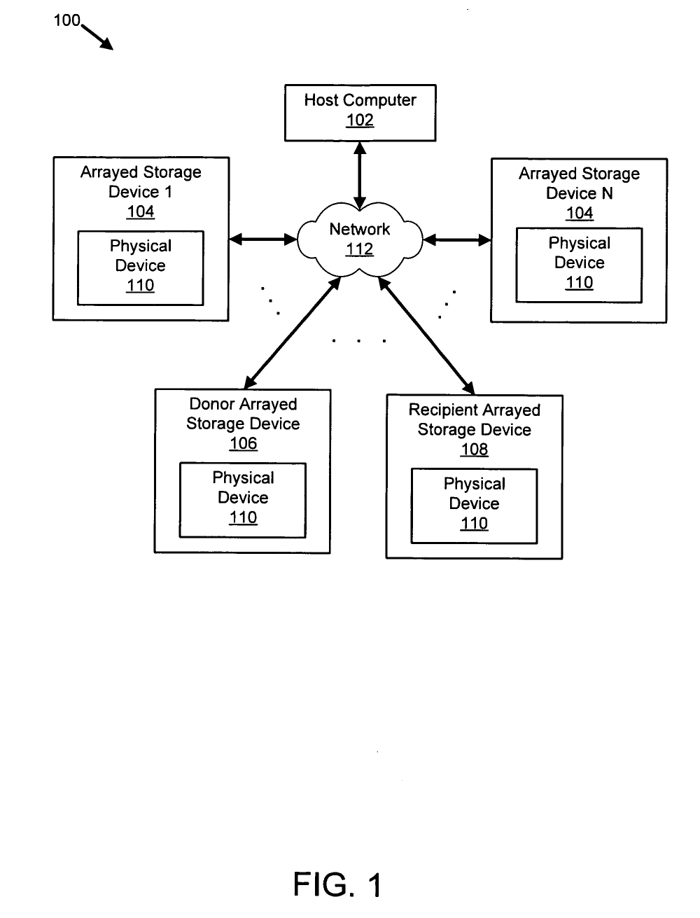

FIG. 1 depicts a schematic block diagram of one embodiment of a storage system 100. The storage system 100 stores data and mission-critical applications and provides a system user interface. The illustrated storage system 100 includes a host computer 102, a plurality of arrayed storage devices 104, a donor arrayed storage device 106, a recipient arrayed storage device 108, and a network 112. The storage system 100 may interface a system user and storage resources according to the interface operations of the host computer 102. The storage system 100 may autonomously detect when a system component is added or removed. In one embodiment, the storage system 100 may include two or more host computers 102.

The host computer 102 manages the interface between the system user and the operating system of the storage system 100. Each host computer 102 may be a mainframe computer. Alternatively, the host computer 102 may be a server, personal computer, and/or notebook computer using one of a variety of operating systems. The host computer 102 is connected to the plurality of arrayed storage devices 104 via a storage area network (SAN) or similar network 112.

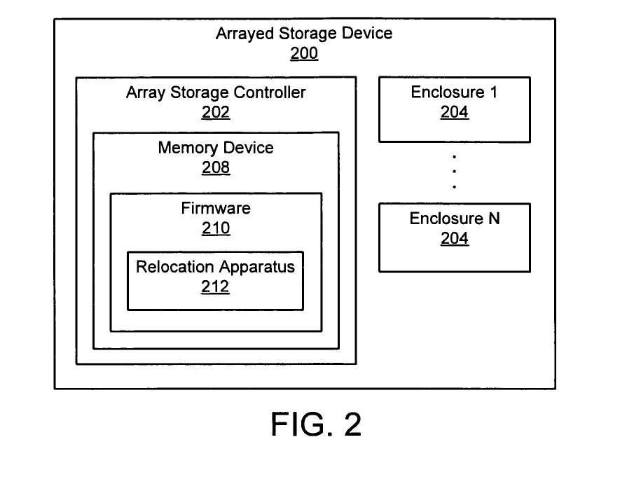

An arrayed storage device 104 encloses a plurality of physical devices 110 which may be configurable as logically linked devices. A system user may configure an arrayed storage device 104 via the host computer 102 to comprise one or more RAID level configurations. Among the plurality of arrayed storage devices 104 may be a donor arrayed storage device 106 and a recipient arrayed storage device 108. A more in depth description of the arrayed storage device 104 is included referring to FIG. 2.

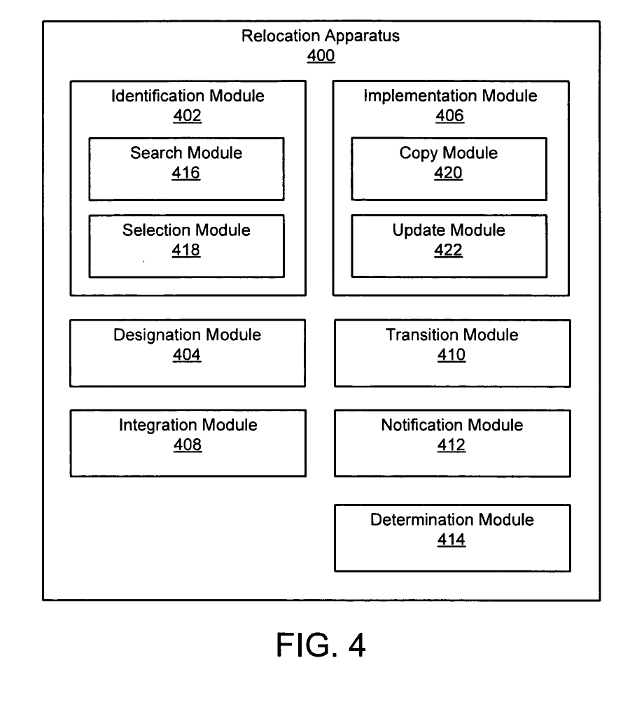

In one embodiment, the donor arrayed storage device 106 may select an enclosed set of physical devices 110 which are then relocated to the recipient arrayed storage device 108 according to predefined operations for relocating an enclosed set of physical devices 110. A more in depth description of the donor arrayed storage device 106 is included referring to FIG. 4.

The network 112 may communicate traditional block I/O, such as over a storage area network (SAN). The network 112 may also communicate file I/O, such as over a transmission control protocol/internet protocol (TCP/IP) network or similar communication protocol. Alternatively, the host computer 102 may be connected directly to the plurality of arrayed storage devices 104 via a backplane or system bus. In one embodiment, the storage system 100 comprises two or more networks 112.

The network 112, in one embodiment, may be implemented using small computer system interface (SCSI), serially attached SCSI (SAS), internet small computer system interface (iSCSI), serial advanced technology attachment (SATA), integrated drive electronics/advanced technology attachment (IDE/ATA), common internet file system (CIFS), network file system (NFS/NetWFS), transmission control protocol/internet protocol (TCP/IP), fiber connection (FICON), enterprise systems connection (ESCON), or any similar interface.

FIG. 2 depicts one embodiment of an arrayed storage device 200 that may be substantially similar to the arrayed storage device 104 of FIG. 1. The arrayed storage device 200 includes an array storage controller 202 and a plurality of enclosures 204. The arrayed storage device 200 may provide a plurality of connections to attach enclosures 204 similar to the IBM® TotalStorage DS8000 and DS6000 series high-capacity storage systems. The connections between the arrayed storage device 200 and the enclosures 204 may be a physical connection, such as a bus or backplane, or may be a networked connection.

The array storage controller 202 controls I/O access to the physical devices 110 attached to the arrayed storage device 200. The array storage controller 202 communicates with the host computer 102 through the network 112. The array storage controller 202 may be configured to act as the communication interface between the host computer 102 and the components of the arrayed storage device 200. The array storage controller 202 includes a memory device 208. In one embodiment, the arrayed storage device 200 comprises a plurality of array storage controllers 202.

When the host computer 102 sends a command to write or access data on a logical device in the arrayed storage device 200, the array storage controller 202 may receive the command and determine how the data will be written and accessed on the logical device. In one embodiment, the array storage controller 202 is a small circuit board populated with integrated circuits and one or more memory devices 208. The array storage controller 202 may be integrated in the arrayed storage device 200. In another embodiment, the array storage controller 202 may be independent of the arrayed storage device 200.

The memory device 208 may act as a buffer (not shown) to increase the I/O performance of the arrayed storage device 200, as well as store microcode designed for operations of the arrayed storage device 200. The buffer, or cache, is used to hold the results of recent reads from the arrayed storage device 200 and to pre-fetch data that has a high chance of being requested in the near future. The memory device 208 may consist of one or more non-volatile semiconductor devices, such as a flash memory, static random access memory (SRAM), non-volatile random access memory (NVRAM), electrically erasable programmable read-only memory (EEPROM), erasable programmable read only memory (EPROM), NAND/AND, NOR, divided bit-line NOR (DINOR), or any other similar memory device. The memory device 208 includes firmware 210 designed for arrayed storage device 200 operations.

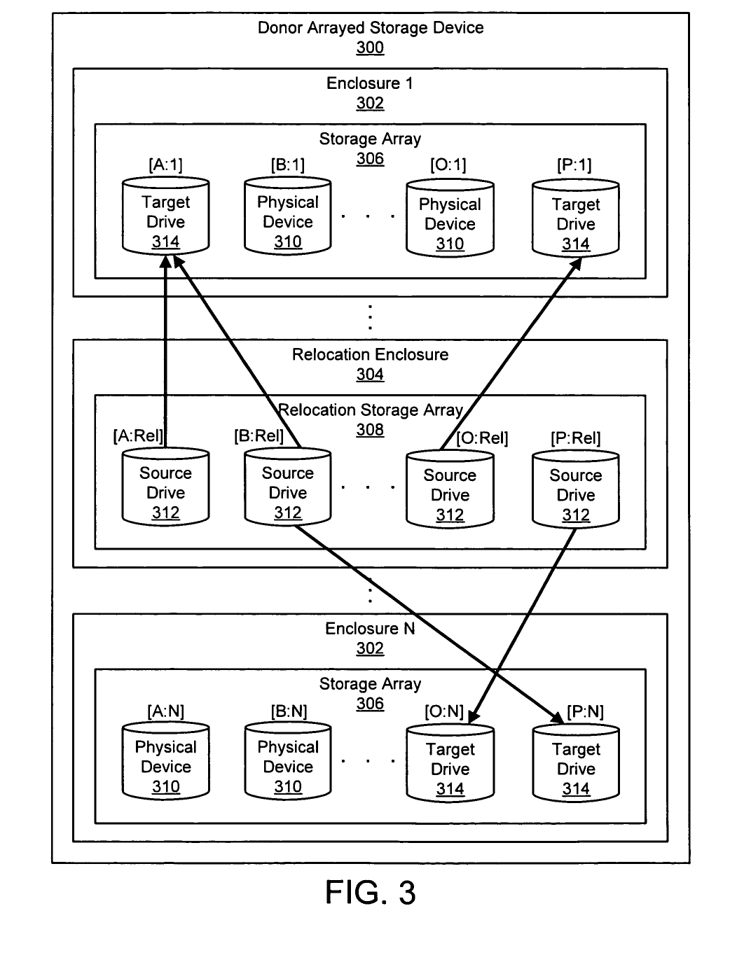

The firmware 210 may be stored on a non-volatile semiconductor or other type of memory device. Many of the operations of the arrayed storage controller 202 are determined by the execution of the firmware 210. The firmware 210 includes a relocation apparatus 212. In general, the relocation apparatus 212 may implement a RAID array relocation process on the arrayed storage device 200. One example of the relocation apparatus 212 is shown and described in more detail with reference to FIG. 3.

The enclosure 204 encloses a plurality of physical devices 110. In one embodiment, the enclosure 204 may include a plurality of hard disk drives connected in a DASD chain. In another embodiment, the enclosure 204 may include a plurality of magnetic tape storage subsystems. Thus, the enclosure 204 encloses a grouped set of physical devices 110 that may be linked to form one or more logical devices.

FIG. 3 depicts one embodiment of a donor arrayed storage device 300 that may be substantially similar to the donor arrayed storage device 106 of FIG. 1. As with the depiction of the arrayed storage device 200 referring to FIG. 2, the depiction of the donor arrayed storage device 300 is for illustrative purposes depicting a function of a relocation process and as such may not illustrate a complete set of components included in a donor arrayed storage device 300.

The donor arrayed storage device 300 provides a RAID array for removal and relocation to another arrayed storage device 200 within the storage system 100, or to another system. The donor arrayed storage device 300 includes a plurality of enclosures 302, and a relocation enclosure 304 selected from among the plurality of enclosures 302. The enclosure 302 may be substantially similar to the enclosure 204 of FIG. 2.

As previously described, the enclosure 302 is an enclosed space to which a plurality of physical devices 110 may be attached. The enclosure 302 includes a storage array 306. In one embodiment, the enclosure 302 is a self-contained removable storage compartment. The enclosure 302 may be hot-swappable, or hot-pluggable. Thus, the enclosure 302 may be added or removed without powering down the storage system 100. Additionally, the storage system 100 may autonomously detect when the enclosure 302 is added or removed.

The storage array 306 may comprise a plurality of attached physical devices 310, such as a plurality of DASD (direct access storage device) hard disk drives. In one embodiment, the storage array 306 comprises a plurality of fibre-channel disk drives configured to communicate over high speed fibre-channel. The storage array 306 includes a plurality of physical devices 310 and/or target drives 314. The target drive 314 is a physical device 310, and is a subset of the plurality of physical devices 310 attached to an enclosure 302. The target drive 314 is selected to offload data from the physical devices 310 attached to the relocation enclosure 304.

In a further embodiment, the storage array 306 may be hot-swappable, allowing a system user to remove the enclosure 302 and/or storage array 306 and replace a failed physical device 310 without shutting down the bus or the storage system 100 to which the enclosure 302 is attached.

In other embodiments, the storage array 306 may comprise a plurality of solid-state memory devices, a plurality of magnetic tape storage, or any other similar storage medium. The storage array 306 may provide individual access to the connection slot to each physical device 310 allowing hot-swappable removal or addition of individual physical devices 310.

The storage array 306 is depicted with a single row of sixteen attached physical devices 310, columns A through P, represented as [Column:Row] for illustrative purposes. The column designates the span of physical devices 310 attached to a storage array 306. The physical devices 310 are depicted as a single row, therefore, the row designates the span of enclosures 302 attached to one arrayed storage device 200. For example, the [A:1] physical device 310 is located in column “A” and row “1” on the first enclosure 302, and the [A:Rel] physical device 310 is located in column “A” and the row relative to the row in which the relocation enclosure 304 resides. The designation of columns and rows is for illustrative purposes, and may vary in size and configuration.

The relocation enclosure 304 is selected from among the plurality of enclosures 302 attached to the donor arrayed storage device 300 according to the operations of the relocation process. The relocation enclosure 304 includes a relocation storage array 308. When an enclosure 302 is found to match the characteristics specified for a relocation enclosure 304, the selected enclosure 302 is designated the relocation enclosure 304 and the attached storage array 306 is then designated the relocation storage array 306. The arrayed storage device 200, to which the relocation enclosure 304 is attached, may then be designated the donor arrayed storage device 300.

The relocation enclosure 304 is selected to offload all stored data that is stored on the storage array 306 attached to the relocation enclosure 304. A physical device 310 attached to the relocation storage array 308 may be designated as a source drive 312. The relocation storage array 308 comprises the plurality of source drives 312 that store the data distributed to other physical devices 310 attached to other enclosures 302.

The relocation storage array 308 includes a plurality of source drives 312. A source drive 312 is physical device 310 attached to the relocation enclosure 304. The source drive 312 comprises the data that is offloaded to a target drive 314. The data stored on a source drive 312 attached to the relocation enclosure 304 may be distributed to a target drive 314 attached to another enclosure 302. In one embodiment, the data is redistributed amongst the plurality of other enclosures 302 currently attached to the donor arrayed storage device 300.

The physical devices 310 attached to other enclosures 302 that match the characteristics of the source drives 312 attached to the relocation storage array 308 may then be linked and the stored data distributed, and the physical devices 310 may then be designated as target drives 314. Thus, the plurality of source drives 312 attached to the relocation enclosure 304 offload all stored data, and one or more source drives 312 are matched to one or more target drives 314 according to the best-match in the associated RAID levels and any other characteristics of a source drive 312.

In certain embodiments, the data stored on a source drive 312 attached to the relocation storage array 308 are distributed to one or more target drives 314 attached to one or more other enclosures 302. In other embodiments, the data stored on multiple source drives 312 attached to the relocation storage array 308 are distributed to one or more other target drives 314 comprised in one or more other enclosures 302. In a further embodiment, the distribution of data stored on a source drive 312 may be distributed via the network 112 to a target drive 314 of an enclosure 302 on another arrayed storage device 200.

For example, as depicted in FIG. 3, the data stored on the [A:Rel] source drive 312 may be distributed to the [A:1] target drive 314. In certain embodiments, the data stored on the [B:Rel] source drive 312 may also be distributed to the [A:1] target drive 314 in addition to the [P:N] target drive 314. The depiction in FIG. 3 then skips to column “O” of the relocation storage array 308 where the data stored on the [O:Rel] source drive 312 may be distributed to the [P:1] target drive 314 and the data stored on the [P:Rel] source drive 312 may be distributed to the [O:N] target drive 314.

FIG. 4 depicts a schematic block diagram of one embodiment of a relocation apparatus 400 that may be substantially similar to the relocation apparatus 212 of FIG. 2. The relocation apparatus 400 implements a relocation process to relocate a RAID array from one location to another while providing uninterrupted availability to mission-critical system applications. The relocation apparatus 400 may be implemented in conjunction with the arrayed storage device 200 of FIG. 2.

The process to relocate a RAID array by the relocation apparatus 400 provides a method to maintain concurrent I/O access to all system data during the relocation process. Thus, the operations of the relocation apparatus 400 allow a system user to remove an attached enclosure 302 while avoiding the vulnerability of running the arrayed storage device 200 in degraded mode.

The relocation apparatus 400 includes an identification module 402, a designation module 404, an implementation module 406, an integration module 408, a transition module 410, a notification module 412 and a determination module 414. In one embodiment, the relocation apparatus 400 is implemented in microcode within the array storage controller 202. In another embodiment, the relocation apparatus 400 may be implemented in a program stored directly on one of the disks comprised in the storage array 306.

The relocation apparatus 400 may be activated according to a relocation protocol. In one embodiment, the relocation module 400 may follow a relocation protocol to establish the characteristics of the RAID array to be selected for relocation. The relocation module 400 may then search an arrayed storage device 200 for a specified relocation enclosure 304, continuing the search until an enclosure 302 is found that matches the characteristics specified.

In one embodiment, a system user may determine the characteristics for a relocation enclosure 304. The characteristics for the relocation enclosure 304 may include total storage capacity of the relocation enclosure 304, the amount of total storage capacity currently being used, the type of storage within the relocation enclosure 304, the individual storage capacity of each storage device attached to the relocation enclosure 304, the age of the relocation enclosure 304, and other similar characteristics. In another embodiment, the host computer 102 may determine the criteria for the relocation enclosure 304.

The identification module 402 identifies a physical device 310 attached to an arrayed storage device 200 as available to offload the data contents of a source drive 312 attached to a donor arrayed storage device 300. The identification module 402 includes a search module 416 that searches for a best match to each physical device 310 attached to the relocation enclosure 304, and a selection module 418 that selects the best match to each physical device 310 attached to the relocation enclosure 304.

In one embodiment, the identification module 402 may identify a physical device 310 as a candidate target drive 314. In a further embodiment, a system user may free or reallocate space on one or more candidate target drives 314 to enable the identification module 402 to identify one or more available target drives 314. In another embodiment, the identification module 402 may identify an arrayed storage device 200 connected to a storage system 100 supports removal of an enclosure 302. The identification module 402 may then identify an arrayed storage device 200 as a candidate for the donor arrayed storage device 300. Additionally, the identification module 402 may identify an enclosure 302 attached to the donor arrayed storage device 300 as a candidate for the relocation enclosure 304.

The search module 416 searches for a best match to a physical device 310 attached to the relocation enclosure 304 in order to offload a mirror copy of all stored data from the physical device 310 attached to the relocation enclosure 304 to a physical device 310 attached to another enclosure 302. In one embodiment, the search module 416 may search an arrayed storage device 200 for a specified size and type of enclosure 302 according to characteristics of a preferred relocation enclosure 304. In certain embodiments, the search module 416 may find a plurality of best matches for a single physical device 310 and/or may find a single best match for a plurality of physical devices 310.

The selection module 418 selects a best match to offload the mirror copy of all stored data from the physical device 310 attached to the relocation enclosure 304 to a physical device 310 attached to another enclosure 302. In one embodiment, the selection module 418 may select an arrayed storage device 200 in order to search for an arrayed storage device 200 that supports removal of an attached enclosure 302.

In another embodiment, the selection module 418 may select a plurality of best matches to offload a single physical device 310 attached to the relocation enclosure 304. Alternatively, the selection module 418 may select a single best match to offload a plurality of physical devices 310 attached to the relocation enclosure 304.

The designation module 404 designates a best match to a physical device 310 attached to a relocation enclosure 304 as a target drive 314. The designation module 404 may also designate the physical device 310 attached to the relocation enclosure 304 as a source drive 312. Thus, the designation module 404 designates a pairing of a source drive 312 linked to a target drive 314. As previously explained, in certain embodiments, the source drive 312 and the target drive 314 may each represent one or more physical devices 310.

The implementation module 406 implements a mirroring relationship between a source drive 312 and a target drive 314. The implementation module 406 includes a copy module 420 that copies the data from the source drive 312 to the target drive 314, and an update module 422 that synchronizes updates between the source drive 312 and the target drive 314 concurrent to the copy process.

In one embodiment, the implementation module 406 implements a RAID level 1 mirroring relationship between the source drive 312 and the target drive 314. Consequently, the implementation module 406 may implement an embedded-RAID within, above or below existing RAID levels that may be currently applied to the physical devices 310 represented by the source drive 312 and/or target drive 314.

The copy module 420 copies the mirror image of all stored data from a source drive 312 to a target drive 314. In one embodiment, the copy module 420 copies the data from the source drive 312 to the target drive 314 concurrent to other tasks running on the donor arrayed storage device 300, thus maintaining access to all stored data and availability to mission-critical applications.

Throughout the copy process, the update module 422 synchronizes any update issued to the source drive 312 with the target drive 314. Thus, updates to the source drive 312 are synchronized concurrently to the target drive 314 throughout the copy process. In one embodiment, the update module 422 passes updates to the source drive 312 and the target drive 314 at the same time. In another embodiment, the update module 422 may send updates to the source drive 312 only when the area where the update is written on the source drive 312 has yet to be copied by the copy module 420 to the target drive 314.

The integration module 408 integrates a target drive 314 as full RAID array member. The target drive 314 is thus integrated with the new data from the source drive 312 copied and stored. The integration module 408 may receive a signal from the copy module 420 indicating the copy process is completed. The copy module 420 may signal the completion of the copy process to the transition module 410 additionally. Accordingly, the implementation module 406 may then remove the mirroring relationship between the source drive 312 and the target drive 314.

The transition module 410 transitions the source drive 312 to a free-state. Once the transition module 410 transitions every source drive 312 attached to the relocation enclosure 304, the transition module 410 may then signal the notification module 412 that all source drives 312 are released into a free-state, and that all target drives 314 are transitioned to full RAID array members.

The notification module 412 notifies the system user of the free-state status of the relocation enclosure 304. In certain embodiments, the notification module 412 notifies the system user that the copy process has finished successfully and that the relocation enclosure 304 is currently safe to remove from the donor arrayed storage device 300. The system user is then free to remove and relocate the relocation enclosure 304 from the donor arrayed storage device 300 and install the relocation enclosure 304 in the recipient arrayed storage device 108.

The determination module 414 determines whether an arrayed storage device 200 contains a specified size and type of enclosure 302. In one embodiment, the determination module 414 determines the characteristics of the specified enclosure 302 for relocation as specified by a system user. In other embodiments, the determination module 414 determines the characteristics of the specified enclosure 302 for relocation as specified by a host computer 102 or some other autonomous process.

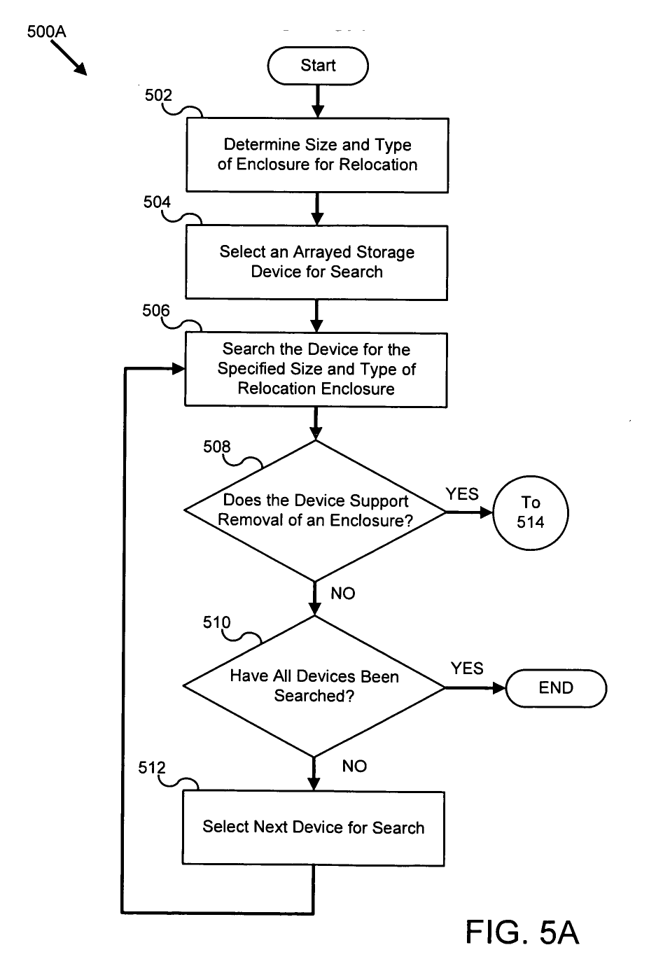

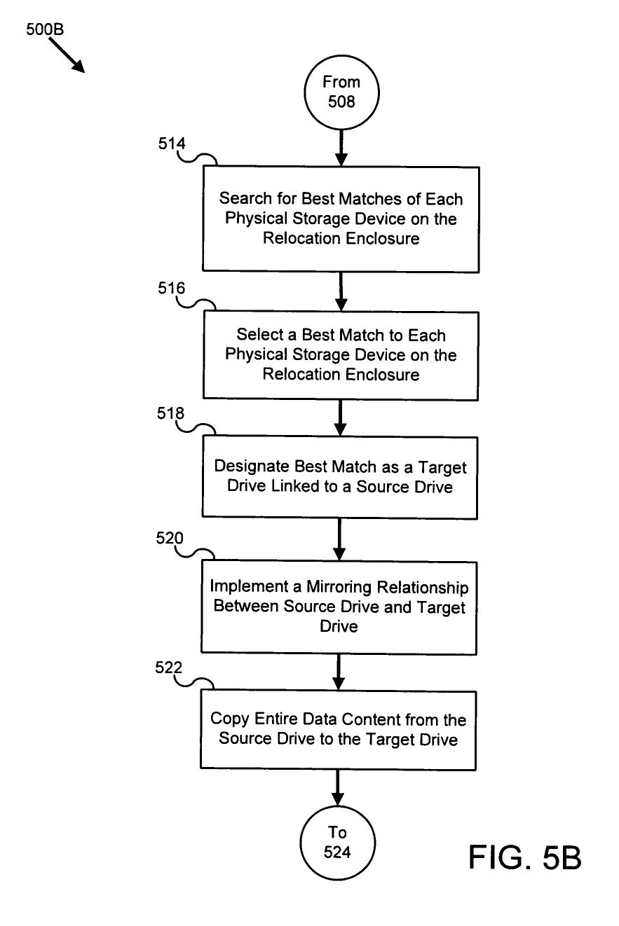

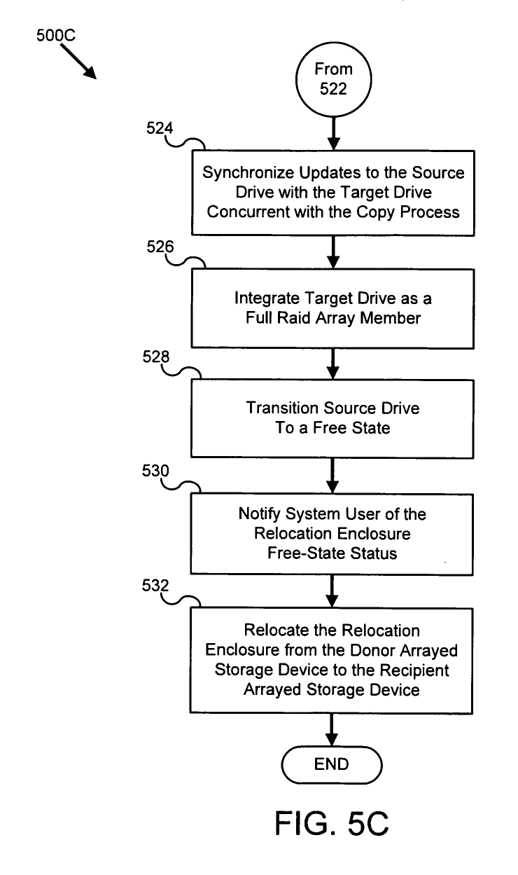

FIGS. 5A, 5B and 5C depict a schematic flow chart diagram illustrating one embodiment of a relocation method 500 that may be implemented by the relocation apparatus 400 of FIG. 4. For convenience, the initialization method 500 is shown in a first part 500A, a second part 500B and a third part 500C, but is referred to collectively as the initialization method 500. The initialization method 500 is described herein with reference to the storage system 100 of FIG. 1.

The relocation method 500A includes operations to determine 502 the size and type of enclosure 302 selected for relocation, select 504 an arrayed storage device 200 for search, search 506 the arrayed storage device 200 for a specified relocation enclosure 304, determine 508 whether the arrayed storage device 200 supports removal of an enclosure 302, determine 510 whether all attached arrayed storage devices 200 have been searched, and select 512 the next arrayed storage device 200 for search.

The relocation method 500B includes operations to search 514 for the best match of each physical device 310 attached to the relocation enclosure 304, select 516 a best match to each physical device 310 attached to the relocation enclosure 304, designate 518 a best match as a target drive 314 linked to a source drive 314, implement 520 a mirroring relationship between a linked source drive 312 and target drive 314, copy 522 the entire data content from a source drive 312 to a target drive 314.

The relocation method 500C includes operations to synchronize 524 updates to the source drive 312 with the target drive 314 concurrent with the copy process, integrate 526 a target drive 314 as a full RAID array member, transition 528 a source drive 312 to a free state, notify 530 a system user of the source drive 312 free-state status, and relocate 532 the relocation enclosure 304 from the donor arrayed storage device 300 to the recipient arrayed storage device 108.

The relocation method 500 initiates the relocation abilities of the relocation apparatus 400 associated with the array storage controller 202. Although the relocation method 500 is depicted in a certain sequential order, for purposes of clarity, the storage system 100 may perform the operations in parallel and/or not necessarily in the depicted order. In one embodiment, the relocation method 500 is executed in association with the array storage controller 202.

The relocation method 500 starts and the determination module 414 determines 502 the size and type of enclosure 302 specified for relocation. In one embodiment, the determination module 414 determines 502 the characteristics of the specified enclosure 302 for relocation as specified by a system user. In other embodiments, the determination module 414 determines 502 the characteristics of the specified enclosure 302 for relocation as specified by a host computer 102 or some autonomous process.

Next, the selection module 418 selects 504 an arrayed storage device 200 for search of a matching enclosure 302 to the specified enclosure 302. Once found, the specified enclosure 302 for relocation may be designated as a relocation enclosure 304. In one embodiment, the designation module 404 may designate the enclosure 302 selected for relocation as the relocation enclosure 304.

Following selection, the search module 416 searches 506 the selected arrayed storage device 200 for the specified size and type of enclosure 302. The determination module 414 then determines 508 whether the selected arrayed storage device 200 supports removal of an attached enclosure 302. The selected arrayed storage device 200 may then be designated as a candidate donor arrayed storage device 300.

In one embodiment, the search module 416 searches 506 every arrayed storage devices 200 attached to the storage system 100 before designating the relocation enclosure 304. After all candidates for donor arrayed storage device 300 are found, the best matches to the specified enclosure 302 among all candidates may be compared and narrowed down until a relocation enclosure 304 is chosen and designated.

If the determination module 414 determines 508 that the selected arrayed storage device 200 supports removal of an attached enclosure 302, the search module 416 searches 514 for a best match to each physical device 310 attached to the relocation enclosure 304. Conversely, if the determination module 414 determines 508 that the selected arrayed storage device 200 does not support removal of an attached enclosure 302, the determination module 414 determines 510 whether the search module 416 has searched 506 every arrayed storage devices 200 attached to the storage system 100.

If the determination module 414 determines 510 that the search module 416 has searched 506 every arrayed storage device 200 attached to the storage system 100, the search process for a relocation enclosure 304 comprised in the storage system 100 terminates. A system user may then select a different storage system 100 to search 506 for the specified enclosure 302. Alternatively, the system user may broaden the characteristics of the specified enclosure 302 and search 506 the same storage system 100 again.

On the contrary, if the determination module 414 determines 510 that the search module 416 has not searched 506 every arrayed storage device 200 attached to the storage system 100, the selection module 418 selects 512 the next arrayed storage device 200 for the search module 416 to search 506.

Following the search module 416 searching 514 for a best match to each physical device 310 attached to the relocation enclosure 304, the selection module 418 selects 516 a best match to a physical device 310 on the relocation enclosure 304. In one embodiment, the designation module 404 designates each physical device 310 attached to the relocation enclosure 304 as a source drive 312.

When a best match to a source drive 312 is found, the designation module 404 may designate 518 the best match as a target drive 314 linked to the source drive 312. In a further embodiment, the designation module 404 may designate the arrayed storage device 200 comprising the relocation enclosure 304 as the donor arrayed storage device 300.

In one embodiment, the best match to a source drive 312 is a single target drive 314. In other words, the source drive 312 and the target drive 314 each are individual physical devices 310. In other embodiments, the source drive 312 and/or target drive 314 may be one or more physical devices 310. Thus, a source drive 312 comprised of a plurality of physical devices 310 attached to the relocation enclosure 304 may link to a target drive 314 comprised of an individual physical device 310. In another embodiment, the source drive 312 comprised of an individual physical device 310 attached to the relocation enclosure 304 may link to a target drive 314 comprised of a plurality of physical devices 310 attached to one or more other enclosures 302.

Next, the implementation module 406 implements 520 a mirroring relationship between the linked source drive 312 and target drive 314. In one embodiment, the implementation module 406 implements a RAID level 1 mirroring relationship between the source drive 312 and target drive 314. Thus, the implementation module 406 may implement 520 a sub-RAID within, above or below other existing RAID levels currently applied to the source drive 312 and/or target drive 314.

The copy module 420 then copies 522 the entire data set stored on the source drive 312 to the target drive 314. The copy module 420 copies 522 the data from the source drive 312 to the target drive 314 concurrent to other tasks running on the donor arrayed storage device 300, allowing all arrayed storage devices 200 attached to the storage system 100 to operate uninterrupted and maintain availability to mission-critical applications.

While the copy module 420 copies 522 the data from the source drive 312 to the target drive 314, the update module 422 synchronizes 524 any update issued to the source drive 312 with the target drive 314. Thus, updates to the source drive 312 are synchronized 524 concurrently to the target drive 314 throughout the copy process.

Once the copy module 420 finishes copying 522 the data from the source drive 312 to the target drive 314, the integration module 408 integrates 526 the target drive 314 as a full RAID array member with the new data from the source drive 312 copied 522 and stored. Accordingly, the RAID level 1 sub-RAID implemented 520 by the implementation module 406 is removed.

In response to the copy module 420 signaling the end of a successful copy process, the transition module 410 then transitions 528 the source drive 312 to a free state. Once the transition module 410 transitions 528 every source drive 312 attached to the relocation enclosure 304, the transition module 410 may then signal the notification module 412 to notify 530 the system user of the free-state status of the relocation enclosure 304. The notification module 412 notifies 530 the system user that the copy process has finished successfully and that the relocation enclosure 304 is currently safe to remove from the donor arrayed storage device 300.

The system user is then free to remove and relocate 532 the relocation enclosure 304 from the donor arrayed storage device 300 and install the relocation enclosure 304 in the recipient arrayed storage device 108. In one embodiment, the system user removes the relocation enclosure 304 from a donor arrayed storage device 300 and relocates 532 the relocation enclosure 304 to an arrayed storage device 200 connected to the same storage system 100. In another embodiment, the system user relocates 532 the relocation enclosure 304 to an arrayed storage device 200 connected to another storage system 100. In a further embodiment, the relocation enclosure 304 is relocated autonomously, similar to the tape retrieval operations of an automated tape library system.

The relocation of a RAID array imparted by the present invention can have a real and positive impact on the efficiency of the overall system. In certain embodiments, the present invention improves uptime, application availability, and real time business performance, all of which results in driving lower the total cost of ownership. In addition to improving utilization of system resources, embodiments of the present invention afford the system user the ability to move a RAID array from one device to another or from one system to another without interrupting the tasks of the overall system or systems affected.

The schematic flow chart diagrams included herein are generally set forth as logical flow chart diagrams. As such, the depicted order and labeled operations are indicative of one embodiment of the presented method. Other operations and methods may be conceived that are equivalent in function, logic, or effect to one or more operations, or portions thereof, of the illustrated method. Additionally, the format and symbols employed are provided to explain the logical operations of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated operations of the depicted method. Additionally, the order in which a particular method occurs may or may not strictly adhere to the order of the corresponding operations shown.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for concurrently relocating a raid array, the apparatus comprising:
an identification module configured to identify an availability of a physical device within an arrayed storage device to offload a source drive of a relocation enclosure;
a designation module coupled to the identification module, the designation module configured to designate an available physical device as a target drive; and
an implementation module coupled to the designation module, the implementation module configured to implement a mirroring relationship between the target drive and the source drive.

2. The apparatus of claim 1, further comprising a search module coupled to the identification module, the search module configured to search among a plurality of physical devices within the donor arrayed storage device for the availability to offload the source drive of the relocation enclosure and to search among a plurality of available physical devices for a best match to the source drive.

3. The apparatus of claim 1, further comprising a selection module coupled to the identification module, the selection module configured to select among a plurality of physical devices within the donor arrayed storage device a plurality of available physical devices and to select among the plurality of available physical devices a best match to the source drive.

4. The apparatus of claim 1, further comprising a copy module coupled to the implementation module, the copy module configured to copy the entire data content of the source drive to the target drive.

5. The apparatus of claim 1, further comprising an update module coupled to the implementation module, the update module configured to synchronize an update to the source drive with the target drive concurrent with a copy process of the copy module.

6. The apparatus of claim 1, further comprising an integration module, the integration module configured to integrate the target drive as a full array member of the donor arrayed storage device in response to the copy module signaling the entire data content of the source drive is mirrored on the target drive.

7. The apparatus of claim 1, further comprising a transition module, the transition module configured to transition the source drive to a free state in response to the copy module signaling the entire data content of the source drive is mirrored on the target drive.

8. The apparatus of claim 1, further comprising a notification module, the notification module configured to notify a system user the relocation enclosure is available for removal.

9. The apparatus of claim 1, further comprising a determination module, the determination module configured to determine whether an arrayed storage device contains a specified size and type of enclosure.

10. A system for concurrently relocating a raid array, the system comprising:
a host computer configured to interface a plurality of arrayed storage devices;
a donor arrayed storage device selected from the plurality of arrayed storage devices coupled to the host computer, the donor arrayed storage device configured to donate a relocation enclosure;
a recipient arrayed storage device selected from the plurality of arrayed storage devices coupled to the host computer, the recipient arrayed storage device configured to receive a relocation enclosure; and
a relocation apparatus coupled to the donor arrayed storage device, the relocation apparatus configured to process operations associated with a relocation procedure.

11. The system of claim 10, wherein the relocation apparatus comprises:
an identification module configured to identify an availability of a physical device within an arrayed storage device to offload a source drive of a relocation enclosure;
a designation module coupled to the identification module, the designation module configured to designate an available physical device as a target; and
an implementation module coupled to the designation module, the implementation module configured to implement a mirroring relationship between the target drive and the source drive.

12. The system of claim 10, wherein the magnetic data storage device comprises an arrayed storage controller, the arrayed storage controller configured to control operations of an arrayed storage device.

13. A signal bearing medium tangibly embodying a program of machine-readable instructions executable by a digital processing apparatus to perform operations for concurrently relocating a raid array, the operations comprising:
identifying an availability of a physical device within a donor arrayed storage device to offload a source drive of a relocation enclosure;
designating an available physical device as a target drive; and
implementing a mirroring relationship between the target drive and the source drive.

14. The signal bearing medium of claim 13, wherein the operations further comprise searching among a plurality of physical devices within the donor arrayed storage device for the availability to offload a source drive of a relocation enclosure and searching among a plurality of available physical devices for a best match to the source drive.

15. The signal bearing medium of claim 13, wherein the operations further comprise selecting among a plurality of physical devices within the donor arrayed storage device one or more available physical devices and selecting among the available physical devices a best match to the source drive.

16. The signal bearing medium of claim 13, wherein the operations further comprise copying the entire data content of the source drive to the target drive.

17. The signal bearing medium of claim 13, wherein the operations further comprise synchronizing an update to the source drive with the target drive concurrent with a copy process of the copy module.

18. The signal bearing medium of claim 13, wherein the operations further comprise integrating the target drive as a full array member of the donor arrayed storage device in response to the copy module signaling the entire data content of the source drive is mirrored on the target drive.

19. The signal bearing medium of claim 13, wherein the operations further comprise transitioning the source drive to a free state in response to the copy module signaling the entire data content of the source drive is mirrored on the target drive.

20. The signal bearing medium of claim 13, wherein the operations further comprise notifying a system user the relocation enclosure is available for removal.
